(19) United States
(12) Patent Application Publication
(10) Pub. No.: US 2026/0073457 A1
(43) Pub. Date: Mar. 12, 2026

(54) WORK SUPPORT SYSTEM USING WEARABLE DEVICE FOR FRONTLINE WORKERS

(71) Applicant: HITACHI, Ltd., Tokyo (JP)

(72) Inventors: Naohiro KOHMU, Santa Clara, CA (US); Riu HIRAI, Cupertino, CA (US); Takuya HABARA, Santa Clara, CA (US); Sudhanshu GAUR, Santa Clara, CA (US)

(21) Appl. No.: 18/827,447

(22) Filed: Sep. 6, 2024

(51) Int. Cl. G06Q 50/04; G06F 3/01; G06F 3/16; G06Q 10/0631; G06V 10/74; G06V 10/77; G06V 10/96; G06V 20/40; G06V 20/52; G06V 40/20; H04N 23/90

(52) U.S. Cl. CPC G06Q 50/04; G06F 3/011; G06F 3/017; G06F 3/167; G06Q 10/06316; G06V 10/761; G06V 10/7715; G06V 10/96; G06V 20/44; G06V 20/52; G06V 40/28; H04N 23/90; G06V 2201/06

(57) ABSTRACT

An operator support system enhances efficiency of users, such as frontline workers, by using a wearable device equipped with cameras, audio interface, and display that captures hand movements and surrounding conditions, which allows for real-time task monitoring and interaction via natural language. The system integrates time-series analysis into a skill assessment mechanism that evaluates users' proficiency by comparing captured task data with pre-stored data. Based on the assessment, a machine learning system tailors user instructions for performing certain tasks. The system adapts to users' individual skill level, thereby improving workflow and reducing disruptions.

### BACKGROUND

### Field

The present disclosure is generally directed to productivity enhancements, and more specifically, to systems and methods for enhancing productivity in manufacturing environments.

### Related Art

As manufacturing processes become increasingly complex, the tasks performed by frontline workers are becoming more intricate. The advancement of factory digitization has led to an increased deployment of fixed digital terminals, such as kiosks, which provide operators with instructions based on work orders that include various subtasks and operational procedures. However, in many factory settings, these digital terminals, along with storage locations for parts, manuals, and assembly work areas, are often situated in separate locations. This spatial separation can cause inefficiencies, particularly when operators encounter situations or uncertainties that fall outside of specific instructions provided. In such cases, operators may need to interrupt their tasks to seek clarification, which disrupts workflow and decreases overall productivity.

To mitigate these problems, there is a growing interest in wearable devices that can be utilized on-site. These devices have the potential to provide real-time assistance and information without requiring users to leave their workstations. Recent advancements in generative AI have further enhanced the functionality of these wearable devices by enabling interaction through natural language. However, tailoring responses from generative AI systems to match the skill level of individual users remains a significant challenge.

Accordingly, what is needed are systems and methods that integrate these technologies into wearable devices to provide skill-level adaptive guidance to operators, thereby improving productivity.

### SUMMARY

In some aspects of the disclosure, a method for assisting operators using a device, such as a wrist-mounted device, comprises: in response to obtaining task-related features associated with time series data associated with an object in a first set of images captured by one or more cameras, accessing a database to obtain task data associated with time-series patterns corresponding to a plurality of skill levels and representing a sequence of actions associated with a task; applying a time-series analysis to the task-related features and the task data to determine a time-series similarity representing a degree of match between the task-related features and the task data; estimating a content of the task based on object recognition results from the time-series similarity; setting a skill level information of a user based on the time-series similarity and the task data; using machine learning to generate an instruction based on at least the skill level information and task-related features; and communicating the instruction to a device coupled to the one or more cameras.

In some aspects, the task-related features include a transition of the object in the first set of images, or a time interval between two events in the time series data that represents a duration of the task.

In some aspects, setting the skill level information comprises accessing a skill assessment table in the database to calculate or adjust the time-series similarity, and generating the instruction comprises using a retrieval-augmented generation (RAG) system that incorporates the skill level information and retrieves information from the database based on task-related features identified in the time-series data. The RAG system may use a user input related to the task to generate the instruction.

In some aspects, the method may further comprise: monitoring a performance of the user during a task execution to gather performance data; analyzing the performance data to adjust the skill level; and storing at least one of the performance data or the user input in a knowledge storage system for future reference. The knowledge storage system may categorize the stored data according to user skill levels to facilitate a revision of at least one of an instruction or a manual.

In some aspects, the device may comprise a first camera that is a wide-angle camera configured to simultaneously capture, in response to obtaining at an audio interface a user instruction in a natural language format, images including hand gestures involving two hands in real time. The device may further comprise a second camera among the one or more cameras that is configured to capture and display a second set of images that represent a surrounding environment.

In some aspects, the techniques described herein relate to a system for assisting operators using a device, the system including: a device coupled to one or more cameras; a database configured to store task data associated with time-series patterns corresponding to a plurality of skill levels and representing a sequence of actions associated with a task; a task estimation unit configured to analyze task-related features associated with time series data from an object in a first set of images captured by the one or more cameras and to estimate a content of the task based on object recognition results from the time-series similarity; a computing and communication system configured to couple to the database and at least one of the device or the task estimation unit, the computing and communication system including: a similarity calculation unit that applies to the task-related features and the task data a time-series analysis to obtain a time-series similarity based on a degree of match between the task-related features and the task data; a skill level determination unit configured to set a skill level information of a user based on the time-series similarity and the task data; and a work instruction generation unit configured to use machine learning to generate an instruction based on at least the skill level information and task-related features, and to communicate the instruction to the device, e.g., a wrist-mounted device.

In some aspects, the system may comprise an audio interface configured to obtain a user instruction in a natural language format, and the device may compromise a first camera that is a wide-angle camera configured to simultaneously capture, in response to the audio interface obtaining the user instruction, images including hand gestures involving two hands in real time.

In some aspects, the computing and communication system may comprise a RAG system that generates the instruction based on the skill level information by retrieving information from the database. The RAG system may use a user input related to the task to generate the instruction.

In some aspects, the device may comprise a second camera configured to capture and display a second set of images that represent a surrounding environment.

In some aspects, the task-related features associated with time series data comprise a transition of the object in the first set of images or a time interval between two events in the time series data that represents a duration of the task.

In some aspects, the system may further comprise a knowledge storage system that categorizes the stored data according to user skill levels to facilitate a revision of at least one of an instruction or a manual. The knowledge storage system may store performance data or the user input for future reference.

In some aspects, the computing and communication system may be configured to monitor and analyze the performance data during a task execution to adjust the skill level.

Aspects of the present disclosure can involve a system, which can involve means for performing steps comprising, in response to obtaining task-related features associated with time series data associated with an object in a first set of images captured by one or more cameras, accessing a database to obtain task data associated with time-series patterns corresponding to a plurality of skill levels and representing a sequence of actions associated with a task; means for applying a time-series analysis to the task-related features and the task data to determine a time-series similarity representing a degree of match between the task-related features and the task data; means for estimating a content of the task based on object recognition results from the time-series similarity; means for setting a skill level information of a user based on the time-series similarity and the task data; means for using machine learning to generate an instruction based on at least the skill level information and task-related features; and means for communicating the instruction to a device coupled to the one or more cameras

### BRIEF DESCRIPTION OF DRAWINGS

FIG. 1 depicts a wearable device, according to various embodiments of the present disclosure.

FIG. 2 is a functional configuration diagram of a skill assessment system, according to various embodiments of the present disclosure.

FIG. 3 is a process flow for determining a user's skill level, according to various embodiments of the present disclosure.

FIG. 4 illustrates details of the processes of steps shown in FIG. 3.

FIG. 5 illustrates details of the work instruction generation process shown in FIG. 3.

FIG. 6 illustrates an alternative wearable device configuration, according to various embodiments of the present disclosure.

FIG. 7 illustrates an alternative functional configuration, according to various embodiments of the present disclosure.

FIG. 8 illustrates a flowchart for generating work instructions in response to user questions, according to various embodiments of the present disclosure.

FIG. 9 illustrates details of the processes of steps shown in FIG. 8.

FIG. 10 depicts a system configuration for storing worker knowledge, according to various embodiments of the present disclosure.

FIG. 11 is a flowchart illustrating an exemplary process for assisting operators using a device in accordance with various embodiments of the present disclosure.

FIG. 12 illustrates an exemplary computing environment with an example computer device, according to various embodiments of the present disclosure.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Existing work-assist devices using AR technology typically require the use of handheld devices, such as smartphones or tablets, which can interrupt workflow and may pose safety risks in factory settings. Site-monitoring solutions that employ fixed cameras are effective for broad monitoring but suffer from blind spots and generally cannot capture detailed hand movements, making it difficult to fully understand the tasks being performed.

Existing first-person video analysis technology that employs head-mounted or wrist-mounted cameras, can capture larger images of objects compared to fixed cameras, potentially improving the recognition rate of workers' tasks. However, head-mounted cameras often capture unnecessary information unrelated to the work, necessitating additional processing to remove irrelevant data, which complicates real-time recognition. Conversely, existing wrist-mounted cameras, while capturing only hands and excluding extraneous information, often capture only one hand, making it difficult to recognize detailed aspects of the work. Therefore, it would be desirable to have systems and methods that support task execution without interrupting workflow, are tailored to a user's skill level, and reduce the workload on workers, thereby improving productivity and efficiency.

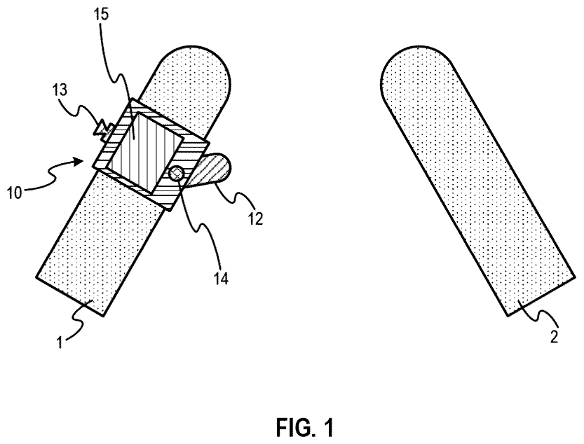

FIG. 1 depicts a wearable device, according to various embodiments of the present disclosure. As depicted, wearable device 10 may be implemented as a wrist-mounted type device that can be worn on a user's left hand (denoted as numeral 1 in FIG. 1) or right hand (denoted as numeral 2).

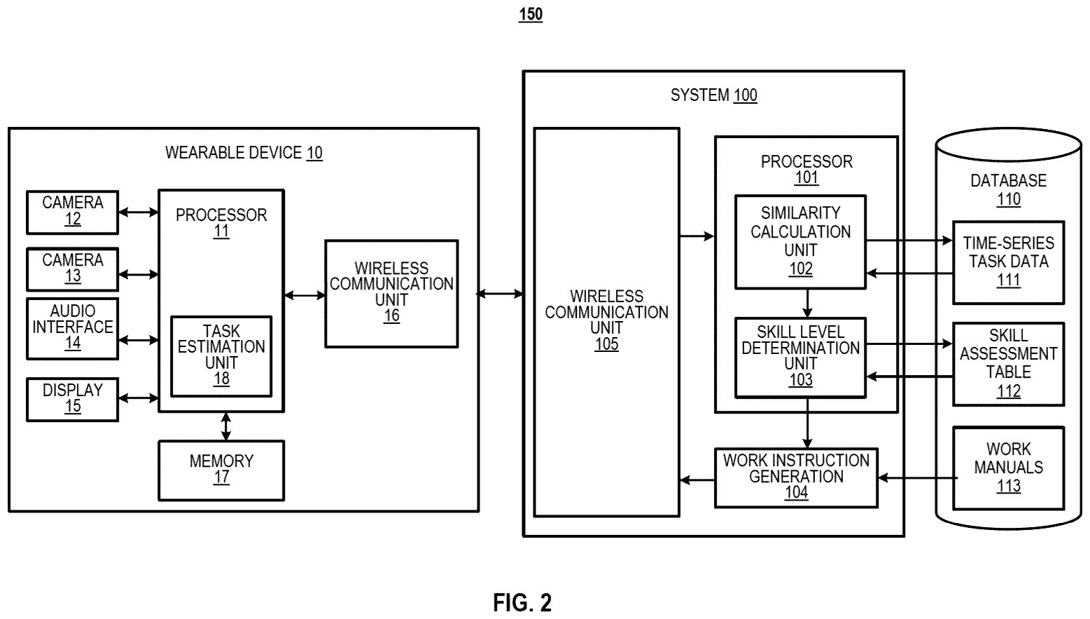

FIG. 2 is a functional configuration diagram of a skill assessment system, according to various embodiments of the present disclosure. In embodiments, skill assessment system 150 comprises wearable device 10, computing and communication system 100, and database 110. As depicted in FIG. 2, wearable device 10 comprises processor 11, cameras 12, 13, audio interface 14, display 15, wireless communication function 16, memory 17, and task estimation unit 18. Computing and communication system 100 comprises processor 101, similarity calculation unit 102, skill level determination unit 103, work instruction generation unit 104, and wireless function 105. Database 110 stores time-series task or feature data 111 corresponding to skill levels, skill assessment table 112 corresponding to a degree of feature similarity, and work manuals 113.

In operation, processor 11 of wearable device 10 may process image data that have been received from one or more cameras 12, 13, as well as audio data from audio interface 14. Wearable device 10 may display the results on display 15. In embodiments, camera 12 may be implemented as a wide-angle camera that is configured to capture the movements of two hand simultaneously, e.g., in real-time, and camera 13 is positioned opposite camera 12 and may be used for recognizing surrounding conditions or capturing images of other devices. Audio interface 14, which comprises a microphone and a speaker, is used to receive user questions in natural language, and play back system responses by system 100. In embodiments, audio interface 14 may utilize a wireless communication device, such as Bluetooth earphones. Display 15 may be used to present simple work instructions and images captured by camera 13. Additionally, display 15 is equipped with touch screen functionality, allowing the user to control and determine a subsequent task by touching the screen. Wireless communication function 16 may be employed to transmit the results processed by processor 11, images captured by cameras 12, 13, and user input via the audio interface 14, as well as to receive responses from system 100. Memory 17 temporarily stores captured images and various data transmitted from computing and communication system 100. Task estimation unit 18 estimates the task content in a time series format based on images captured by camera 12.

In embodiments, processor 101 of computing and communication system 100 may process data transmitted by wearable device 10, including data from similarity calculation unit 102, skill level determination unit 103, and/or work instruction generation unit 104, e.g., to generate instructions, and data from wireless function 105, e.g., for communication with wearable device 10.

Database 110 may store time-series task data 111 corresponding to skill levels, skill assessment table 112, which corresponds to the degree of feature similarity, and work manuals 113. In embodiments, similarity calculation unit 102 may compare feature data calculated by task feature extraction unit 18 of wearable device 10 with feature data 111 stored in database 110 to calculate a time-series similarity. Skill level determination unit 103 may then compare the result calculated by similarity calculation unit 102 with skill assessment table 112 to determine skill level. By inputting the skill level information determined by skill level determination unit 103 and work manual 113, stored in the database, into a generative AI system (not shown), instructions tailored to the user's skill level may be generated. The instructions are then communicated back to the wearable device 10 for display and playback.

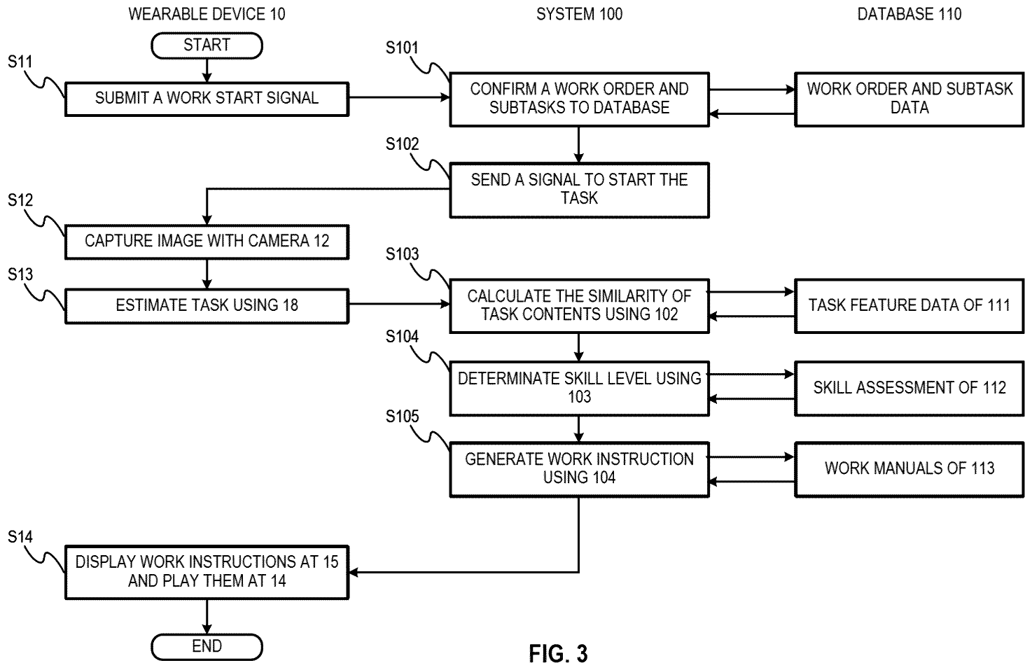

FIG. 3 is a process flow for determining a user's skill level, according to various embodiments of the present disclosure. In embodiments, process 300 may begin at step S11, when, a work start signal is transmitted from a wearable device (such as wearable device 10 shown in FIG. 1) to a computing and communication system (such as system 100 shown in FIG. 1).

At step S101, upon receiving the work start signal, the computing and communication system may access a database to verify a worker's work order and subtasks.

At step S102, the system may transmit a task start signal to the wearable device.

At step S12, upon the wearable device receiving the task start signal, it may activate a camera to capture the worker's tasks, e.g., at regular intervals.

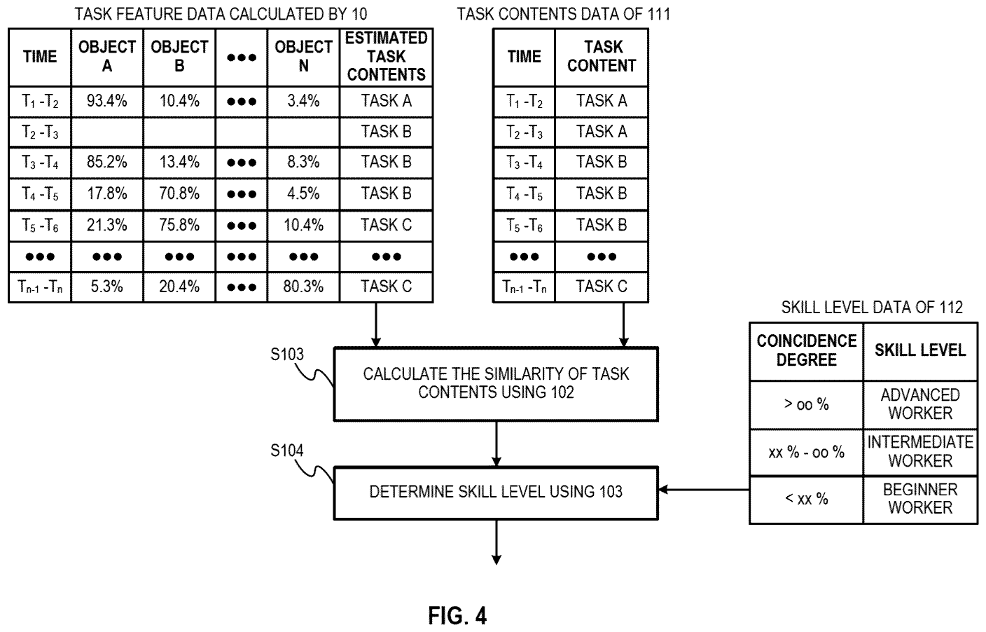

From the images captured in S12, a task estimation unit may estimate the content of the task based on object recognition results, at step S13, and transmit this information to the computing and communication system. Subsequently, a similarity calculation unit (102) may compare the task contents stored in the database (110) with those calculated at step S13 to compute, at step S103, the congruence of the task contents. The data output from the task estimation unit (18) may comprise time-series data that include a recognition rate for each of a number of objects, as indicated in Table 1 in FIG. 4. The data stored in the database (110) may comprise the task content arranged in a time series format.

At step S104, the congruence of the task calculated at step S103 and the skill assessment table 112 may serve as input into the skill level determination unit, e.g., for determining a user's skill level. In embodiments, skill assessment table 112 shown in FIG. 4 enables the calculation of the user's skill level based on the congruence of the task content. It is understood that the relationship between task content congruence and skill level information of the user may be modified according to each work order or subtask. The skill level of the information determined at step S104, along with the work manual (113) stored in the database (110), may be input to the work instruction generation unit (104) to generate, at step S105, work instructions that are tailored to the user's skill level. Finally, at step S14, the generated work instructions may be transmitted to the wearable device (10) for display on the display (15) and playback through audio interface 14.

FIG. 4 illustrates details of the processes of respective steps S103 and S104 shown in FIG. 3, according to various embodiments of the present disclosure. In embodiments, at step S103, the task estimated by the task estimation unit of the wearable device (10) and the task (111) stored in the database (110) serve as input to the congruence calculation unit (102) to calculate the congruence of the task. Subsequently, the result calculated at step S103 may be compared with the user's skill level information data to determine the user's skill level.

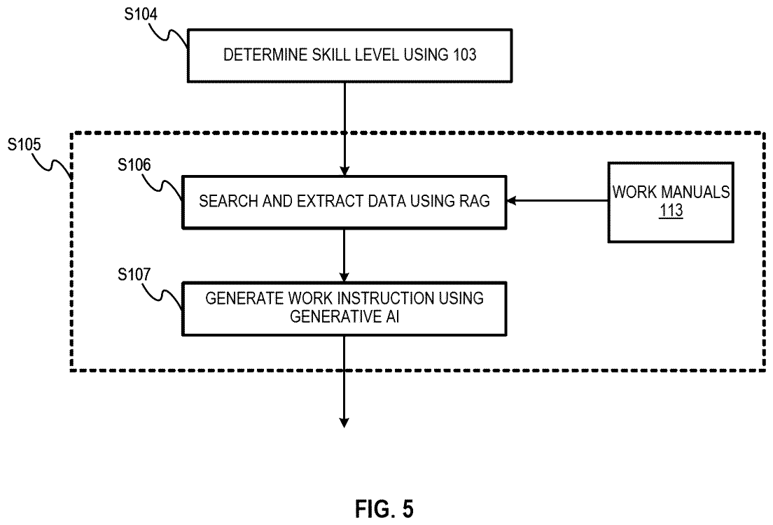

FIG. 5 illustrates details of the work instruction generation process shown in FIG. 3, according to various embodiments of the present disclosure. In embodiments, the work instruction generation process unit (104) takes the skill level calculated at step S104 and the work manual (113) stored in the database (110) as inputs into a RAG system to search for and extract relevant information. The results of the search and extraction may then be provided to a generative AI system (not shown) that generates and outputs appropriate work instructions that may be communicated to the wearable device (10) to facilitate worker assistance.

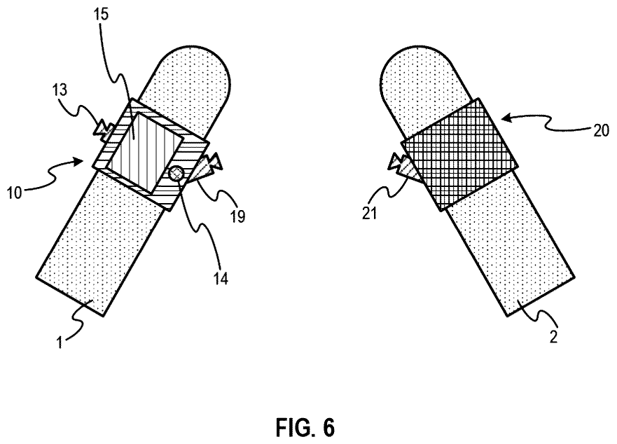

FIG. 6 illustrates an alternative wearable device configuration, featuring cameras on both hands to capture tasks performed by each hand according to various embodiments of the present disclosure. In this configuration, camera 19 on the left hand 1 captures the tasks performed by the right hand 2, while camera 21 on the right hand 2 captures the tasks performed by the left hand 1. Although this configuration increases the number of cameras, it allows each hand's movements to correspond one-to-one with a camera, which is expected to enhance the estimation accuracy in the task estimation unit 18 of the wearable device 10. The wearable device 20 worn on the right hand also has wireless functionality similar to the wearable device 10. The images captured by camera 21 are transmitted to the wearable device 10, where the task estimation unit 18 estimates the task using the results from both camera 20 and camera 21.

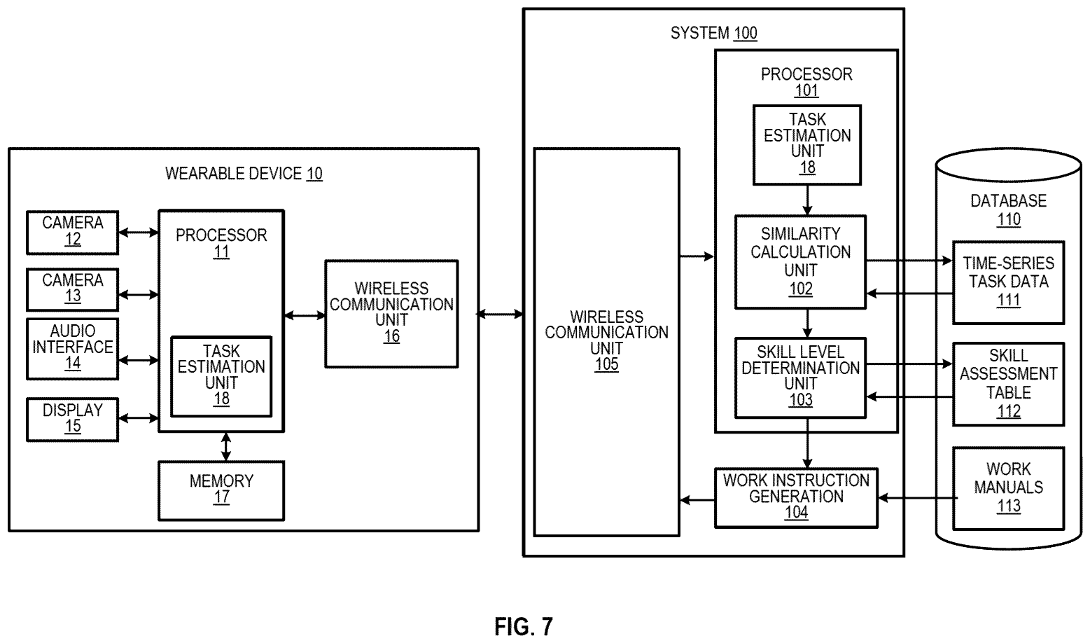

FIG. 7 illustrates an alternative functional configuration according to various embodiments of the present disclosure. In embodiments, the functional configuration of FIG. 2 may be modified as shown in FIG. 7. As depicted in FIG. 7, task estimation unit 18 is included within the processor 101 of computing and communication system 100. As the image data captured by camera 12 of wearable device 10 is also transmitted to computing and communication system 100, there may be a potential decrease in the real-time performance of task estimation. However, since the resources of the system become available, it is possible to execute more extensive deep learning processes (such as object detection and feature extraction) compared to the wearable device 10. This, in turn, potentially enhances the accuracy of task estimation.

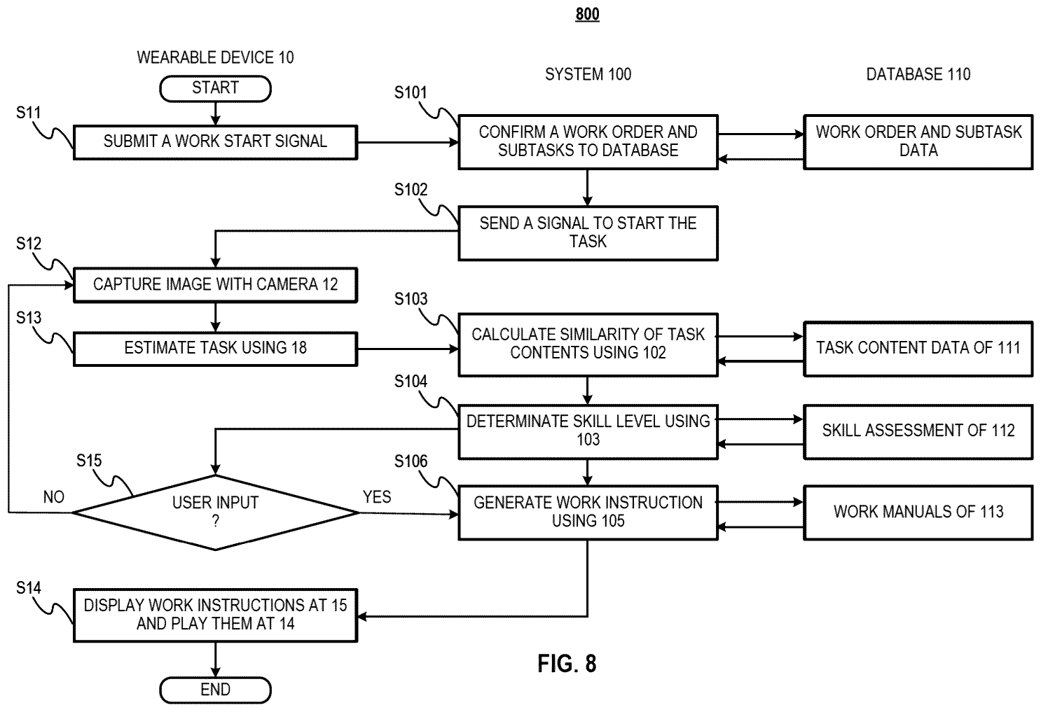

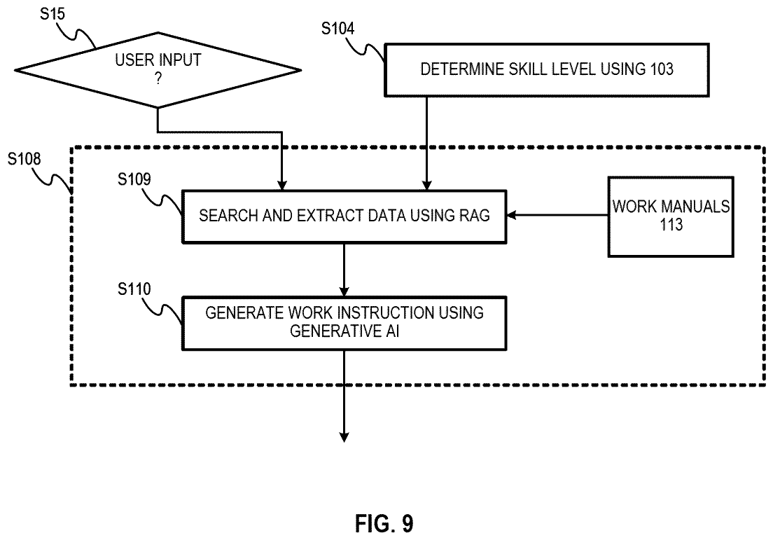

FIG. 8 illustrates a flowchart for generating work instructions in response to user questions, according to various embodiments of the present disclosure. Unlike embodiments associated with FIG. 3, where the system proactively presents the next instruction without requiring a question from the worker, flowchart 800 in FIG. 8 generates work instructions when the user poses a question. The processing steps up to S104 are the same as in FIG. 3. In embodiments, after determining a worker's skill level in S104, the system determines whether a question is detected, e.g., from the wearable device 10. If not, (S15: No), process 800 returns to S12, and the skill level assessment is performed again. If there is a question (S15: Yes), as shown in FIG. 9, the question content from the wearable device (10), the skill level determined at step S104, and the work manual 113 stored in the database (110) may be input into the generative AI to output work instruction at step S108. At step S14, the generated work instruction is then transmitted to the wearable device (10), displayed on the display (15), and played back through the audio interface (14).

In such embodiments, by calculating the worker's skill level before a question arises, it becomes possible to generate a prompt response tailored to the skill level in response to the worker's question.

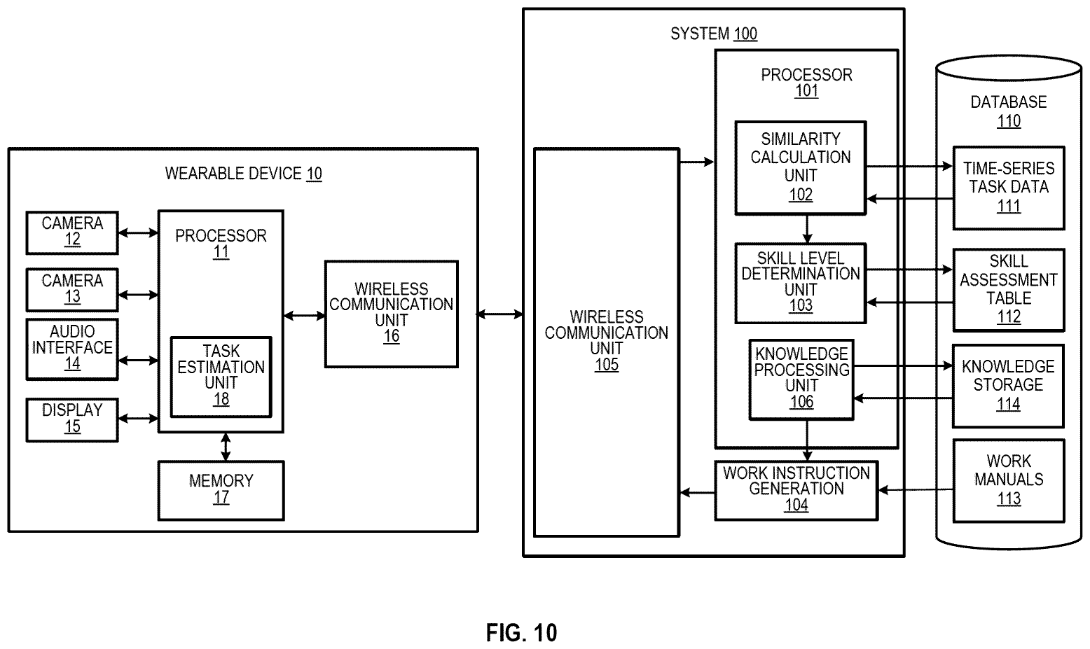

FIG. 10 depicts a system configuration for storing worker knowledge, according to various embodiments of the present disclosure. In embodiments, the knowledge processing unit (106) may categorize and store the user's movements and the content of their questions in the knowledge storage 114, based on skill level determination using skill level determination unit 103, thereby enabling the enhancement of work efficiency and the revision of manuals for better clarity.

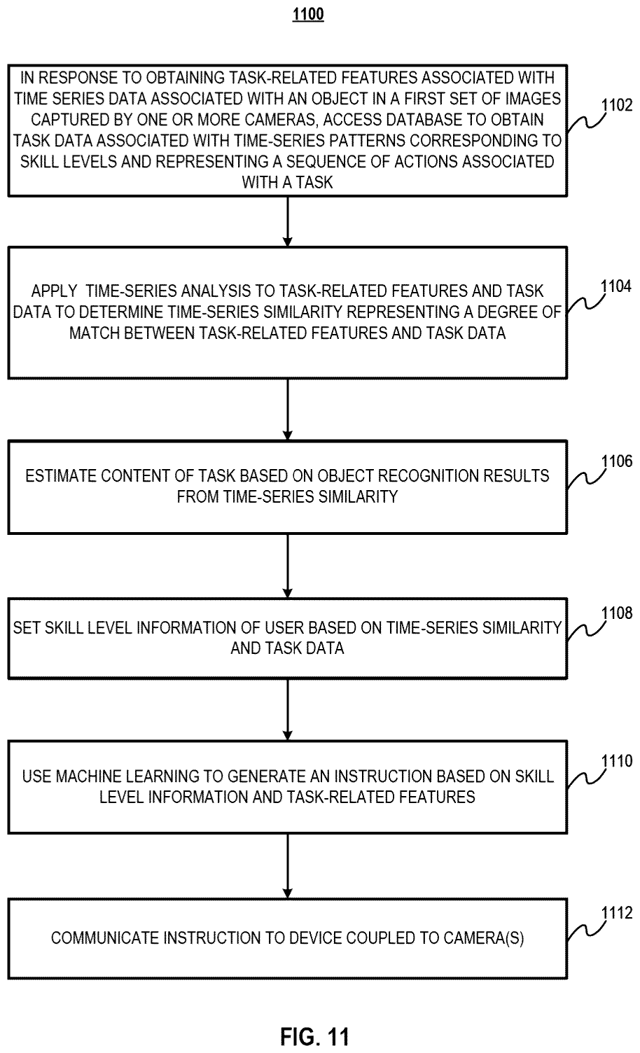

FIG. 11 is a flowchart illustrating an exemplary process for assisting operators using a device in accordance with various embodiments of the present disclosure. In embodiments, process 1100 for assisting operators may start, at step 1102, when in response to a device obtaining task-related features associated with time series data associated with an object in a first set of images captured cameras coupled to the device, a database is accessed. The database stores task data that is associated with time-series patterns that corresponds to a plurality of skill levels and represents a sequence of actions associated with a task.

At step 1104, a time-series analysis may be applied to the task-related features and the task data to determine a time-series similarity which represents a degree of match between the task-related features and the task data.

At step 1106, a content of the task may be estimated based on object recognition results from the first set of images.

At step 1108, a skill level of a user may be determined based on the time-series similarity and the task data.

At step 1110, machine learning may be used to generate an instruction based on at least the skill level and task-related features.

Finally, at step 1120, the instruction may be communicated to the device.

One skilled in the art shall recognize that: (1) certain steps may optionally be performed; (2) steps may not be limited to the specific order set forth herein; (3) certain steps may be performed in different orders; and (4) certain steps may be done concurrently.

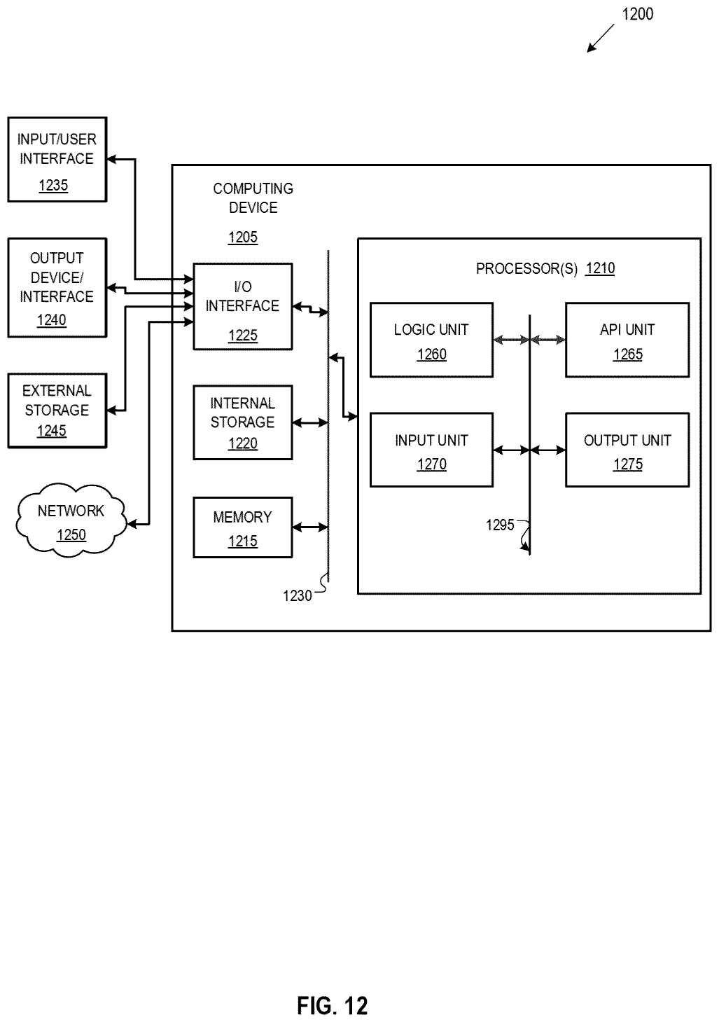

FIG. 12 illustrates an example computing environment with an example computer device suitable for use in some example implementations, according to various embodiments of the present disclosure. Computer device 1205 in computing environment 1200 can include one or more processing units, cores, or processors 1210, memory 1215 (e.g., RAM, ROM, and/or the like), internal storage 1220 (e.g., magnetic, optical, solid-state storage, and/or organic), and/or I/O interface 1225, any of which can be coupled on a communication mechanism or bus 1230 for communicating information or embedded in the computer device 1205. I/O interface 1225 is also configured to receive images from cameras or provide images to projectors or displays, depending on the desired implementation.

Computer device 1205 can be communicatively coupled to input/user interface 1235 and output device/interface 1240. Either one or both of input/user interface 1235 and output device/interface 1240 can be a wired or wireless interface and can be detachable. Input/user interface 1235 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1240 may include a display, television, monitor, printer, speaker, braille, or the like. In some example implementations, input/user interface 1235 and output device/interface 1240 can be embedded with or physically coupled to the computer device 1205. In other example implementations, other computer devices may function as or provide the functions of input/user interface 1235 and output device/interface 1240 for a computer device 1205.

Examples of computer device 1205 may include highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1205 can be communicatively coupled (e.g., via I/O interface 1225) to external storage 1245 and network 1250 for communicating with any number of networked components, devices, and systems, including one or more computer devices of the same or different configurations. Computer device 1205 or any connected computer device can be functioning as, providing services of, or referred to as a server, client, thin server, general machine, special-purpose machine, or another label.

I/O interface 1225 can include wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1200. Network 1250 can be any network or combination of networks (e.g., the Internet, local area network, wide area network, a telephonic network, a cellular network, a satellite network, and the like).

Computer device 1205 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1205 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 1210 can execute under any operating system (OS) (not shown), in a native or virtual environment. One or more applications can be deployed that include logic unit 1260, application programming interface (API) unit 1265, input unit 1270, output unit 1275, and inter-unit communication mechanism 1295 for the different units to communicate with each other, with the OS, and with other applications (not shown). The described units and elements can be varied in design, function, configuration, or implementation and are not limited to the descriptions provided. Processor(s) 1210 can be in the form of hardware processors such as central processing units (CPUs) or a combination of hardware and software units.

In some example implementations, when information or an execution instruction is received by API unit 1265, it may be communicated to one or more other units (e.g., logic unit 1260, input unit 1270, output unit 1275). In some instances, logic unit 1260 may be configured to control the information flow among the units and direct the services provided by API unit 1265, input unit 1270, and output unit 1275, in some example implementations described above. For example, the flow of one or more processes or implementations may be controlled by logic unit 1260 alone or in conjunction with API unit 1265. The input unit 1270 may be configured to obtain input for the calculations described in the example implementations, and the output unit 1275 may be configured to provide output based on the calculations described in example implementations.

Processor(s) 1210 can be configured to execute a method or computer instructions which can involve, in response to obtaining task-related features associated with time series data associated with an object in a first set of images captured by one or more cameras, accessing a database to obtain task data associated with time-series patterns corresponding to a plurality of skill levels and representing a sequence of actions associated with a task, as described, for example, with respect to FIG. 1 and FIG. 2. Processor(s) 1210 can be configured to execute a method or computer instructions which can involve, applying a time-series analysis to the task-related features and the task data to determine a time-series similarity representing a degree of match between the task-related features and the task data, and estimating a content of the task based on object recognition results from the time-series similarity, as described, for example, with respect to FIG. 3 and FIG. 4. Processor(s) 1210 can be configured to execute a method or computer instructions which can involve, setting a skill level information of a user based on the time-series similarity and the task data, using machine learning to generate an instruction based on at least the skill level information and task-related features, and communicating the instruction to a device coupled to the one or more cameras, as described, for example, with respect to FIG. 2 and FIG. 3.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities to achieve a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer-readable medium, such as a computer-readable storage medium or a computer-readable signal medium. A computer-readable storage medium may involve tangible mediums such as optical disks, magnetic disks, read-only memories, random access memories, solid-state devices, drives, or any other types of tangible or non-transitory media suitable for storing electronic information. A computer-readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for assisting operators using a device, the method comprising:
in response to obtaining task-related features associated with time series data associated with an object in a first set of images captured by one or more cameras, accessing a database to obtain task data associated with time-series patterns corresponding to a plurality of skill levels and representing a sequence of actions associated with a task;
applying a time-series analysis to the task-related features and the task data to determine a time-series similarity representing a degree of match between the task-related features and the task data;
estimating a content of the task based on object recognition results from the time-series similarity;
setting a skill level information of a user based on the time-series similarity and the task data;
using machine learning to generate an instruction based on at least the skill level information and task-related features; and
communicating the instruction to a device coupled to the one or more cameras.

2. The method of claim 1, wherein the task-related features associated with time series data comprise a transition of the object in the first set of images.

3. The method of claim 1, wherein the task-related features associated with time series data comprise a time interval between two events in the time series data that represents a duration of the task.

4. The method of claim 1, wherein setting the skill level information comprises accessing a skill assessment table in the database to calculate or adjust the time-series similarity.

5. The method of claim 1, wherein generating the instruction comprises using a retrieval-augmented generation (RAG) system that incorporates the skill level information and retrieves information from the database based on task-related features identified in the time-series data

6. The method of claim 5, wherein the RAG system further uses a user input related to the task to generate the instruction.

7. The method of claim 6, further comprising:
monitoring a performance of the user during a task execution to gather performance data;
analyzing the performance data to adjust the skill level; and
storing at least one of the performance data or the user input in a knowledge storage system for future reference.

8. The method of claim 7, wherein the knowledge storage system categorizes the stored data according to user skill levels to facilitate a revision of at least one of an instruction or a manual.

9. The method of claim 1, wherein the device is a wrist-mounted device, and a first camera among the one or more cameras is a wide-angle camera configured to simultaneously capture, in response to obtaining at an audio interface a user instruction in a natural language format, images comprising hand gestures involving two hands in real time.

10. The method of claim 9, wherein the device comprises a second camera among the one or more cameras that is configured to capture and display a second set of images that represent a surrounding environment.

11. A system for assisting operators using a device, the system comprising:
a device coupled to one or more cameras;
a database configured to store task data associated with time-series patterns corresponding to a plurality of skill levels and representing a sequence of actions associated with a task;
a task estimation unit configured to analyze task-related features associated with time series data from an object in a first set of images captured by the one or more cameras and to estimate a content of the task based on object recognition results from a time-series similarity; and
a computing and communication system configured to couple to the database and at least one of the device or the task estimation unit, the computing and communication system comprising:
a similarity calculation unit that applies to the task-related features and the task data a time-series analysis to obtain the time-series similarity based on a degree of match between the task-related features and the task data;
a skill level determination unit configured to set a skill level information of a user based on the time-series similarity and the task data; and
a work instruction generation unit configured to use machine learning to generate an instruction based on at least the skill level information and task-related features, and to communicate the instruction to the device.

12. The system of claim 11, further comprising an audio interface configured to obtain a user instruction in a natural language format.

13. The system of claim 12, wherein the device is a wrist-mounted device and a first camera among the one or more cameras is a wide-angle camera configured to simultaneously capture, in response to the audio interface obtaining the user instruction, images comprising hand gestures involving two hands in real time.

14. The system of claim 11, wherein the computing and communication system comprises a retrieval-augmented generation (RAG) system that generates the instruction based on the skill level information by retrieving information from the database.

15. The system of claim 14, wherein the RAG system further uses a user input related to the task to generate the instruction.

16. The system of claim 11, wherein the device comprises a second camera among the one or more cameras that is configured to capture and display a second set of images that represent a surrounding environment.

17. The system of claim 11, wherein the task-related features associated with time series data comprise at least one of a transition of the object in the first set of images or a time interval between two events in the time series data that represents a duration of the task.

18. The system of claim 15, further comprising a knowledge storage system that categorizes the stored data according to user skill levels to facilitate a revision of at least one of an instruction or a manual.

19. The system of claim 18, wherein the knowledge storage system stores at least one of performance data or the user input for future reference.

20. The system of claim 19, wherein the computing and communication system is configured to monitor and analyze the performance data during a task execution to adjust the skill level.
